(19) United States
(12) Patent Application Publication
(10) Pub. No.: US 2010/0328015 A1
(43) Pub. Date: Dec. 30, 2010

(54) APPARATUS FOR COUPLING AN ACTUATOR

(75) Inventors: Anssi Ilmari Vanska, Helsinki (FI); Matti Tauno Pekka Kosonen, Jarvenpaa (FI); Jarkko Tapio Rouvinen, Espoo (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/492,919

(22) Filed: Jun. 26, 2009

(51) Int. Cl. H01H 71/18

(52) U.S. Cl. 337/123

(57) ABSTRACT

In accordance with an example embodiment of the present invention, an apparatus, comprises an actuator assembly, which comprises an actuator and a coupling mechanism, the coupling mechanism having a curved surface, the actuator having a leading contact point with the curved surface, the actuator having an end coupled with a stationary point, the actuator comprising a shape memory alloy adapted to pull the coupling mechanism in a direction tangential to the leading contact point toward the stationary point when heated.

### TECHNICAL FIELD

The present application relates generally to an apparatus for coupling an actuator.

### BACKGROUND

One type of actuator is a shape memory alloy (SMA) actuator. An SMA actuator is a wire manufactured using a shape memory alloy, which contracts when heated. Heating takes place by conducting current through the wire. Some SMA actuators are helically shaped and others comprise a straight wire.

### SUMMARY

Various aspects of examples of the invention are set out in the claims.

According to a first aspect of the present invention, an apparatus comprises an actuator assembly, which comprises an actuator and a coupling mechanism, the coupling mechanism having a curved surface, the actuator having a leading contact point with the curved surface, the actuator having an end coupled with a stationary point, the actuator comprising a shape memory alloy adapted to pull the coupling mechanism in a direction tangential to the leading contact point toward the stationary point when heated.

According to a second aspect of the present invention, an apparatus comprises an actuator assembly, which comprises an actuator and a coupling mechanism, the coupling mechanism comprising a tap and a bushing, the tap being rotatable with respect to the bushing, the actuator coupled with the tap, the actuator having an end coupled with a stationary point, the actuator comprising a shape memory alloy adapted to pull said coupling mechanism toward the stationary point when heated.

According to a third aspect of the present invention, an apparatus comprises an actuator assembly, which comprises an actuator and a pulley, the pulley having a curved surface, the actuator having a leading contact point with the curved surface, the actuator having an end coupled with a stationary point, the actuator comprising a shape memory alloy adapted to pull the coupling mechanism in a direction tangential to the leading contact point toward the stationary point when heated.

### BRIEF DESCRIPTION OF THE DRAWINGS

For a more complete understanding of example embodiments of the present invention, reference is now made to the following descriptions taken in connection with the accompanying drawings in which:

FIG. 1A is a diagram of an apparatus comprising an actuator assembly, which comprises a coupling mechanism having a curved surface and a helically-shaped actuator in a contracted configuration according to an example embodiment of the invention;

FIG. 1B is a diagram of an apparatus comprising an actuator assembly, which comprises a coupling mechanism having a curved surface and a helically-shaped actuator in an expanded configuration according to an example embodiment of the invention;

FIG. 1C is a diagram of the apparatus of FIG. 1A with an actuator assembly comprising a coupling mechanism having a curved surface and a straight actuator according to an example embodiment of the invention;

FIG. 2 is a diagram of an apparatus with an actuator assembly comprising a coupling mechanism, which comprises a tap and a bushing according to an example embodiment of the invention;

FIG. 3 is an isometric view of the actuator assembly of FIG. 2 according to an example embodiment of the invention;

FIG. 4 is an isometric view of an actuator assembly having a loop and a tap according to an example embodiment of the invention;

FIG. 5 is an isometric view of an actuator assembly comprising a form having guide groove for an actuator according to an example embodiment of the invention; and

FIG. 6 is a diagram of an apparatus comprising an actuator assembly according to an example embodiment of the invention.

### DETAILED DESCRIPTON OF THE DRAWINGS

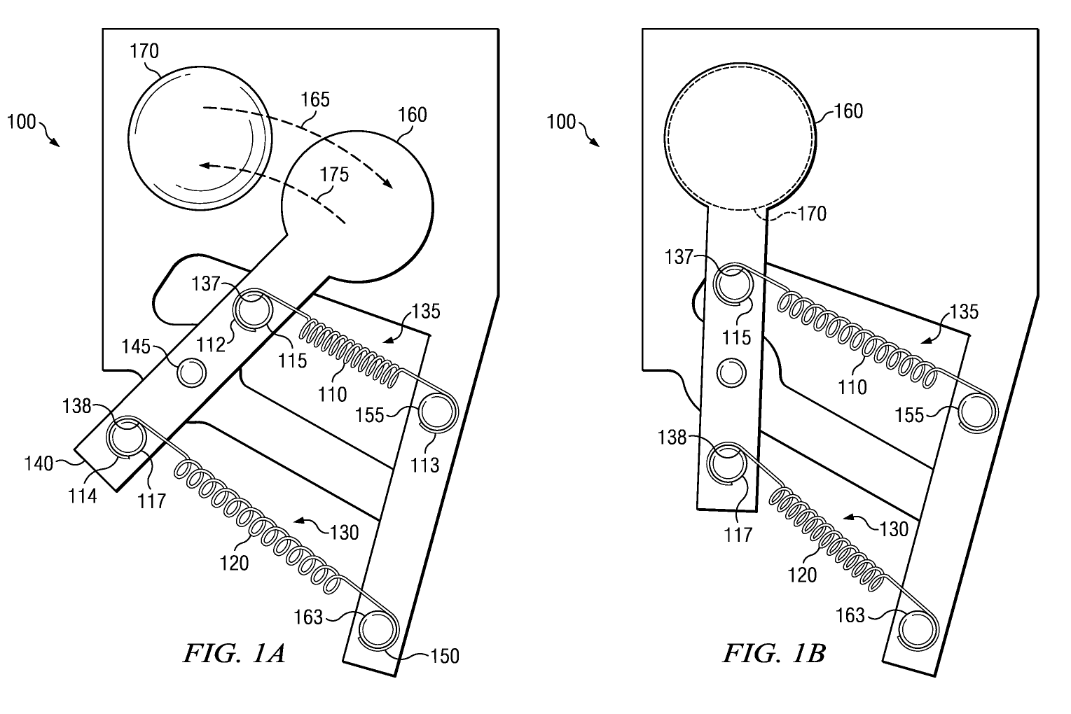

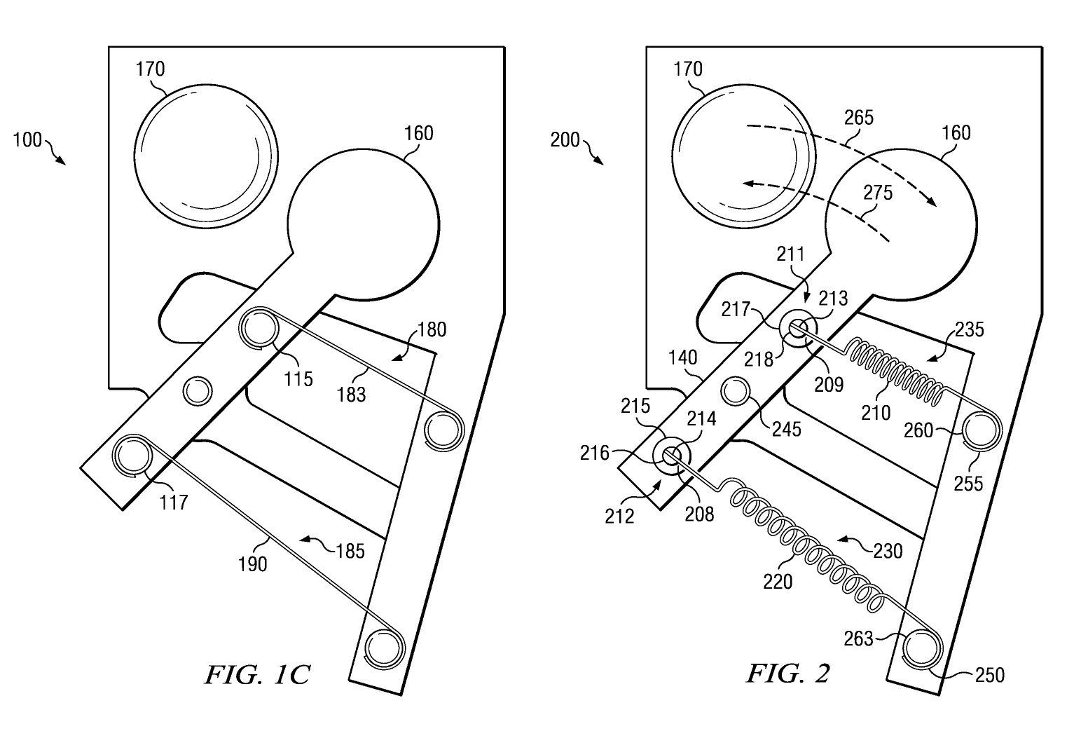

An example embodiment of the present invention and its potential advantages are understood by referring to FIGS. 1 through 6 of the drawings.

FIG. 1A is a diagram of an apparatus 100 comprising an actuator assembly 135, which comprises a coupling mechanism 115 having a curved surface and a helically-shaped actuator 110 in a contracted configuration according to an example embodiment of the invention. FIG. 11B is a diagram of an apparatus 100 comprising an actuator assembly 135, which comprises a coupling mechanism 115 having a curved surface and a helically-shaped actuator 110 in an expanded configuration according to an example embodiment of the invention. In an example embodiment, apparatus 100 is an ultra slim reveal module for a camera; however, apparatus may be any electronic and/or mechanical device. In FIG. 1A, a reveal module for a camera provides protection for a camera lens 170 by covering camera lens 170 with a protective cover 160. Protective cover 160 is coupled with arm 140. Arm 140 is coupled with actuator assembly 135 comprising coupling mechanism 115 and actuator 110. Coupling mechanism 115 has a curved surface on which a straight end 112 of actuator 110 is at least partially wrapped or coiled. Actuator 10 has a leading contact point 137 with curved surface of coupling mechanism 115. Actuator 110 may be coupled with curved surface of coupling mechanism 115. Actuator 110 is manufactured using a shape memory alloy. At least a portion of actuator 110 is helically shaped. The other straight end 113 of actuator 10 is coupled with a stationary point 155. Stationary point 155 may comprise a coupling mechanism similar to coupling mechanism 115 that has a curved surface on which the other straight end 113 of actuator 110 is at least partially wrapped or coiled. Arm 140 comprises a pivot point 145 allowing arm 140 to rotate in either a clockwise or a counter-clockwise direction.

Arm 140 is coupled with another actuator assembly 130 comprising a coupling mechanism 117 and actuator 120. Coupling mechanism 117 has a curved surface on which a straight end 114 of actuator 120 may be at least partially wrapped or coiled. Actuator 120 has a leading contact point 138 with curved surface of coupling mechanism 117. Actuator 120 comprises a shape memory alloy. Actuator 120 may be coupled with curved surface of coupling mechanism 117. At least a portion of actuator 120 is helically shaped. The other straight end 150 of actuator 120 is coupled to a stationary point 170. Stationary point 170 may comprise a coupling mechanism similar to coupling mechanism 117 that has a curved surface on which the other straight end 150 of actuator 120 is at least partially wrapped or coiled.

When actuator 110 is heated by an electric current, the shape memory alloy in actuator 110 will cause actuator 110 to chance from an expanded configuration (FIG. 1B) to a contracted configuration (FIG. 1A). When actuator 110 contracts, actuator 110 pulls coupling mechanism 115 and arm 140 toward stationary point 155 rotating arm 140 clockwise in the direction of arrow 165 about pivot point 145. When arm 140 rotates in the direction of arrow 165, protective cover 160 moves away from camera lens 170 uncovering the lens. When actuator 110 pulls arm 140 toward stationary point 155, actuator 110 pulls coupling mechanism 115 coupled with arm 140 in a direction tangential to actuator's 110 leading contact point 137 with curved surface of coupling mechanism 115. As arm 140 rotates about pivot point 145 in a direction according to arrow 165, leading contact point 137 moves counter clockwise along the curved surface of coupling mechanism 115. However, actuator 110 will continue to pull coupling mechanism 115 in a direction tangential to actuator's 110 leading contact point even as the leading contact point moves counter clockwise along the curved surface of coupling mechanism 115. Pulling coupling mechanism 115 in a direction tangential to actuator's 110 leading contact point with curved surface of coupling mechanism 115 minimizes mechanical stress of the actuator reducing wear over time.

When actuator 120 is heated by an electric current, the shape memory alloy in actuator 120 will cause actuator 120 to change from an expanded configuration (FIG. 1A) to a contracted configuration (FIG. 1B). When actuator 120 contracts, actuator 120 pulls coupling mechanism 117 and arm 140 toward stationary point 170. Actuator 120 pulls coupling mechanism 117 coupled with arm 140 in a direction tangential to actuator's 120 leading contact point 138 with curved surface of coupling mechanism 130. As arm 140 rotates about pivot point 145 in a direction according to arrow 175, leading contact point 138 will move clockwise along the curved surface of coupling mechanism 117. However, actuator 120 will continue to pull coupling mechanism 120 in a direction tangential to actuator's 120 leading contact point even as the leading contact point moves clockwise along the curved surface of coupling mechanism 117. Pulling coupling mechanism 117 in a direction tangential to actuator's 120 leading contact point with curved surface of coupling mechanism 130 minimizes mechanical stress of the actuator reducing wear over time.

In an alternate example embodiment, at least a portion of actuators 110 and 120 may be straight. FIG. 1C is a diagram of the apparatus 100 of FIG. 1A with an actuator assembly 180 comprising a coupling mechanism 115 having a curved surface and actuator 183 according to an example embodiment of the invention. At least a portion of actuator 183 is straight. FIG. 1C shows another actuator assembly 185 comprising a coupling mechanism 117 having a curved surface and actuator 190 according to an example embodiment of the invention. Actuator 190 is straight. In an example embodiment, straight actuators 183 and 190 of FIG. 1C are manufactured using a shape memory alloy as helically-shaped actuators 110 and 120 of FIG. 1A.

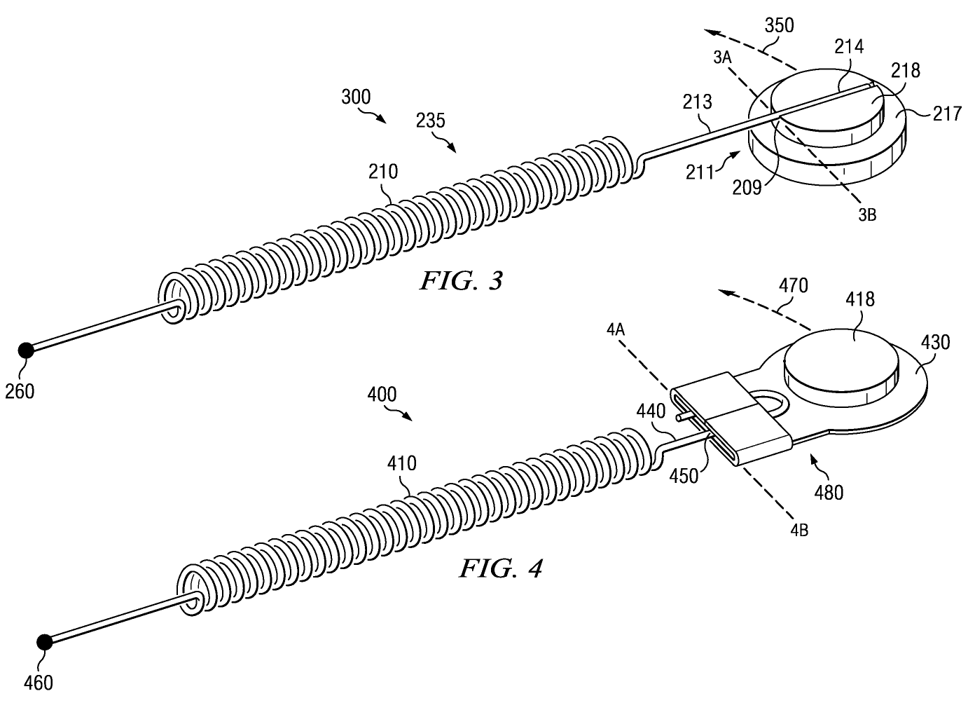

FIG. 2 is a diagram of an apparatus 200 with an actuator assembly 235 comprising a coupling mechanism 211, which comprises a tap 218 and a bushing 217 according to an example embodiment of the invention. FIG. 3 is an isometric view of an alternative actuator assembly 235 (FIG. 2) according to an example embodiment of the invention. In an example embodiment, apparatus 200 (FIG. 2) is an ultra slim reveal module for a camera; however, apparatus 200 may be any electronic and/or mechanical device. A reveal module for a camera provides protection for a camera lens 170 as originally shown in FIG. 1 by covering camera lens 170 with a protective cover 160 (FIG. 1 and FIG. 2). Protective cover 160 is coupled with arm 140 as originally shown in FIG. 1. Arm 140 is coupled with actuator assembly 235 (FIG. 2 and FIG. 3), which comprises coupling mechanism 211 and actuator 210. Coupling mechanism 211 comprises a tap 218 and a bushing 217. Bushing 217 is coupled with arm 140. Tap 218 is rotatable with respect to bushing 217, which does not rotate. Straight end 213 of actuator 210 is coupled to top of tap 218 such that the tangent 3A-3B (FIG. 3) of actuator's 210 leading contact point 209 with tap 218 is perpendicular with straight end 213.

Actuator 210 comprises a shape memory alloy. At least a portion of actuator 210 is helically-shaped; however, in an alternate example embodiment, actuator 210 may be straight. The other straight end 255 of actuator 210 is coupled with stationary point 260. Stationary point 260 may comprise a coupling mechanism, such as coupling mechanism 115 (FIG. 1) that has a curved surface on which the other straight end 255 of actuator 210 is at least partially wrapped or coiled. In an alternate example embodiment, stationary point 260 may comprise a coupling mechanism such as coupling mechanism 211

According to FIG. 2, arm 140 comprises a pivot point 245 allowing arm 140 to rotate in either a clockwise or a counter-clockwise direction. Arm 140 is coupled with another actuator assembly 230 comprising a coupling mechanism 212 and actuator 220. Coupling mechanism 212 comprises a tap 216 and a bushing 215. Tap 216 is rotatable with respect to bushing 215, which does not rotate. Bushing 217 is coupled with arm 140. Straight end 214 of actuator 220 is coupled to top of tap 216 such that the tangent of actuator's 220 leading contact point 208 with tap 216 is perpendicular with straight end 214 as illustrated in FIG. 3 for actuator assembly 235 (FIG. 3).

The other straight end 250 of actuator 220 is coupled with a stationary point 263. Stationary point 263 may comprise a coupling mechanism, such as coupling mechanism 115 (FIG. 1) that has a curved surface on which the other straight end 250 of actuator 220 is at least partially wrapped or coiled. In an alternate example embodiment, stationary point 260 may comprise a coupling mechanism such as coupling mechanism 212.

When actuator 210 is heated by an electric current, the shape memory alloy in actuator 210 will cause actuator 210 to contract. When actuator 210 contracts, actuator 210 pulls arm 140 toward stationary point 260 rotating arm 140 clockwise in the direction of arrow 265 about pivot point 245. When arm 140 rotates in the direction of arrow 265, protective cover 160 moves away from camera lens 170 uncovering the lens. When actuator 210 pulls arm 140 toward stationary point 260, actuator 210 pulls coupling mechanism 211 coupled with arm 140 in a direction toward stationary point 260 rotating tap 218 counter-clockwise with respect to bushing 217 such that the tangent 3A-3B (FIG. 3) of actuator's 210 leading contact point 209 with tap 218 remains perpendicular with straight end 214. Pulling coupling mechanism 211 in a direction perpendicular to the tangent 3A-3B (FIG. 3) of actuator's 110 leading contact point 209 with curved surface of coupling mechanism 117 minimizes mechanical stress of the actuator reducing wear over time.

Further, when actuator 220 pulls arm 140 toward stationary point 250, actuator 220 pulls coupling mechanism 212 coupled with arm 140 in a direction perpendicular to the tangent of actuator's 220 leading contact point 208 with curved surface of coupling mechanism 212 as illustrated in FIG. 3 for actuator assembly 235 (FIG. 3). As arm 140 rotates about pivot point 245 in a direction according to arrow 275, leading contact point 208 will move clockwise with respect to bushing 215 along the curved surface of coupling mechanism 212. However, actuator 220 will continue to pull coupling mechanism 212 in a direction perpendicular to the tangent of actuator's 220 leading contact point 208 even as the leading contact point moves clockwise along the curved surface of coupling mechanism 212. Pulling coupling mechanism 212 in a direction perpendicular to the tangent of actuator's 110 leading contact point with curved surface of coupling mechanism 212 minimizes mechanical stress of the actuator reducing wear over time.

In an example embodiment of the invention, at least a portion of actuators 210 and 220 may be helically-shaped. In an alternate example embodiment, at least a portion of actuators 210 and 220 may be straight.

FIG. 4 is an isometric view of an actuator assembly 400 having a loop 430 and a tap 418 according to an example embodiment of the invention. In an example embodiment, actuator assembly 400 may be used in apparatus 200 (FIG. 2) as an alternative to actuator assembly 235 and/or actuator assembly 230. Actuator assembly 400 comprises an actuator 410 and a coupling mechanism 480. Coupling mechanism 480 comprises a tap 418 and loop 430. Loop 430 is coupled with tap 418 such that loop 430 may rotate freely with respect to tap 418, which does not rotate. A straight end 440 of actuator 410 is coupled with loop 430 and has a leading contact point 450 with loop 430. Straight end 460 of actuator 410 is coupled with loop 430 such that straight end 440 of actuator 410 is perpendicular to line 4A-4B. Line 4A-4B intersects leading contact point 450 at an edge of loop 430. In an example embodiment, if actuator 400 is used alternatively to actuator 235 (FIG. 2), the other straight end 460 of actuator 410 is coupled with stationary point 260 (FIG. 2) and tap 418 is coupled with arm 140 (FIG. 2). In another example embodiment, if actuator 400 is used alternatively to actuator 230 (FIG. 2), the other straight end 460 of actuator 410 is coupled with stationary point 263 (FIG. 2) and tap 418 is coupled with arm 140 (FIG. 2).

The following example describes actuator's 400 functionality in apparatus 200 (FIG. 2) when actuator assembly 400 is used in place of to actuator assembly 235 (FIG. 2). When actuator 410 (FIG. 2) pulls arm 140 (FIG. 2) toward stationary point 260 (FIG. 2), actuator 410 pulls coupling mechanism 480 coupled with arm 140 (FIG. 2) in a direction toward stationary point 260 rotating loop 430 counter-clockwise with respect to tap 418. Straight end 440 of actuator 410 remains perpendicular with dotted line 4A-4B (FIG. 4) which intersects leading contact point 450 at the edge of loop 430. Pulling coupling mechanism 400 in a direction perpendicular to dotted line 4A-4B (FIG. 4) minimizes mechanical stress of the actuator reducing wear over time.

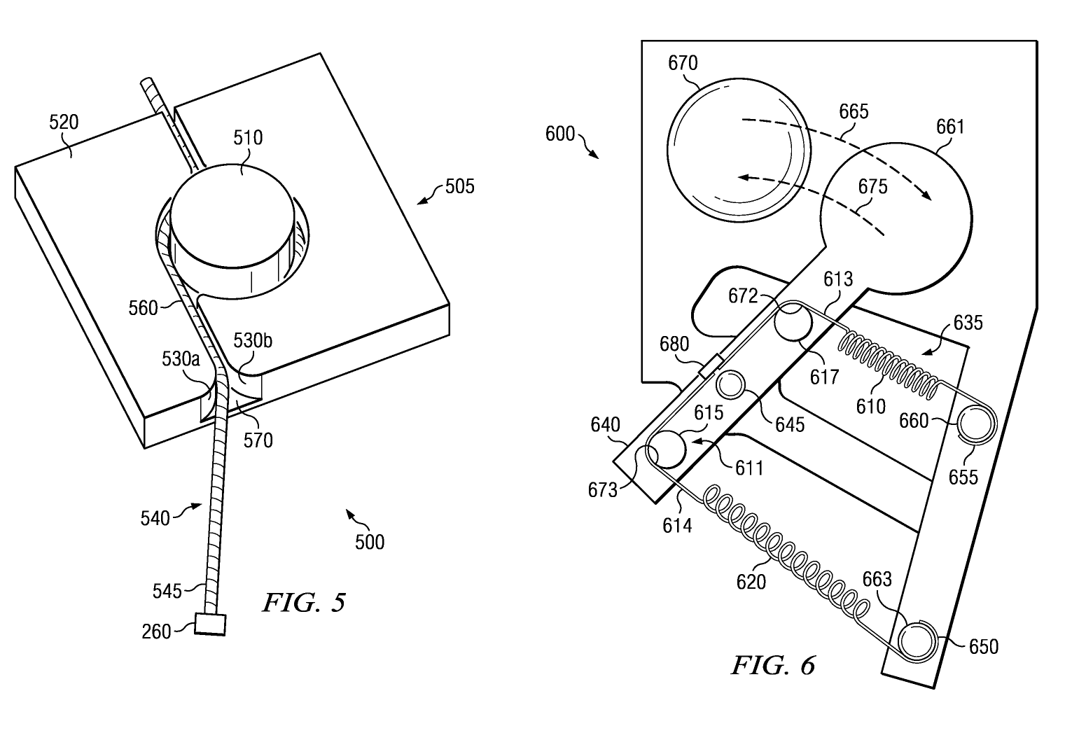

FIG. 5 is an isometric view of an actuator assembly 500 comprising a form 520 having a guide groove 560 for an actuator 540 according to an example embodiment of the invention. In an example embodiment, actuator assembly 500 may be used in apparatus 200 (FIG. 2) as an alternative to actuator assembly 235 and/or actuator assembly 230. Actuator assembly 500 comprises an actuator 540 and a coupling mechanism 505. Coupling mechanism 505 comprises a tap 510 and a form 520 having at least one guide groove 560. Tap 510 does not rotate with respect to form 520. Actuator 540 is coupled with tap 510 through guide groove 560. Actuator 540 exits guide groove 560 in form 520 through an opening 570 in guide groove 560. Opening 570 has curved exit walls 530a and 530b.

In an example embodiment, if actuator 500 is used alternatively to actuator 235 (FIG. 2), the other straight end 545 of actuator 540 is coupled with stationary point 260 (FIG. 2). In another example embodiment, if actuator 500 is used alternatively to actuator 230 (FIG. 2), the other straight end 545 of actuator 540 is coupled with stationary point 263 (FIG. 2). In either example embodiment, form 520 is coupled with arm 140.

The following example describes actuator assembly 500 functionality in apparatus 200 (FIG. 2) when actuator assembly 500 is used alternatively to actuator assembly 235 (FIG. 2). When actuator 540 pulls arm 140 (FIG. 2) toward stationary point 260 (FIG. 2), actuator 540 pulls coupling mechanism 505 coupled with arm 140 (FIG. 2) in a direction toward stationary point 260. FIG. 5 shows that the angle of the pulling of actuator 540 forces actuator 540 to make contact with and be at least partially wrapped with curved exit wall 530a minimizing mechanical stress of the actuator reducing wear over time.

FIG. 6 is a diagram of an apparatus 600 comprising an actuator assembly 635 according to an example embodiment of the invention. In an example embodiment, apparatus 600 is an ultra slim reveal module for a camera; however, apparatus 600 may be any electronic and/or mechanical device. Protective cover 661 is coupled with arm 640. Arm 640 is coupled with actuator assembly 635, which comprises pulley mechanism 611, actuator 610 and actuator 620. Pulley mechanism 611 comprises pulley 617 and pulley 615. Both pulley 617 and pulley 615 are rotatable with respect to arm 640. Straight end 613 of actuator 610 is wrapped partially around pulley 617.

Actuator 610 is manufactured using a shape memory alloy. At least a portion of actuator 610 is helically-shaped; however, in an alternate example embodiment, actuator 610 may be straight. The other straight end 655 of actuator 610 is coupled to a stationary point 660. Stationary point 660 may comprise a coupling mechanism, such as coupling mechanism 115 (FIG. 1) that has a curved surface on which the other straight end 655 of actuator 610 is at least partially wrapped or coiled. In an alternate example embodiment, stationary point 660 may comprise a coupling mechanism such as coupling mechanism 211 (FIG. 2).

According to FIG. 6, arm 640 comprises a pivot point 645 allowing arm 640 to rotate in either a clockwise or a counter-clockwise direction. Arm 640 is coupled with pulley 615, which is rotatable with respect to arm 640. Straight end 614 of actuator 620 is wrapped partially around pulley 615. Straight end 614 of actuator 620 and straight end 613 of actuator 610 are coupled with grounding point 680, which provides an electrical grounding point for both actuators.

The other straight end 650 of actuator 220 is coupled with a stationary point 663. Stationary point 663 may comprise a coupling mechanism, such as coupling mechanism 115 (FIG. 1) that has a curved surface on which the other straight end 650 of actuator 620 is at least partially wrapped or coiled. In an alternate example embodiment, stationary point 660 may comprise a coupling mechanism such as coupling mechanism 212 (FIG. 2).

When actuator 610 is heated by an electric current, the shape memory alloy within actuator 610 will cause actuator 610 to contract. When actuator 610 contracts, actuator 610 pulls arm 640 toward stationary point 660 rotating arm 640 clockwise in the direction of arrow 665 about pivot point 645. When arm 640 rotates in the direction of arrow 665, protective cover 160 moves away from camera lens 670 uncovering the lens. When actuator 610 pulls arm 640 toward stationary point 655, actuator 610 pulls pulley mechanism 611 coupled with arm 140 in a direction tangential to actuator's 610 leading contact point 672 with curved surface of pulley 617. Pulling pulley mechanism 611 in a direction tangential to leading contact point 672 with curved surface of pulley 617 minimizes mechanical stress of the actuator reducing wear over time.

Further, when actuator 620 pulls arm 640 toward stationary point 663, actuator 220 pulls pulley mechanism 611 coupled with arm 640 in a direction tangential to actuator's 620 leading contact point 673 with curved surface of pulley 615. As arm 640 rotates about pivot point 645 in a direction according to arrow 675, leading contact point 673 will move clockwise along the curved surface of pulley 615. However, actuator 620 will continue to pull pulley mechanism 611 in a direction tangential to actuator's 620 leading contact point 673 with pulley 615 even as the leading contact point moves clockwise along the curved surface of pulley 615. Pulling pulley mechanism 611 in a direction tangential to actuator's 620 leading contact point 672 with curved surface of pulley 615 minimizes mechanical stress of the actuator reducing wear over time.

In an example embodiment of the invention, at least a portion of actuators 610 and 620 may be helically shaped. In an alternate example embodiment, at least a portion of actuators 610 and 620 may be straight.

Without in any way limiting the scope, interpretation, or application of the claims appearing below, a technical effect of one or more of the example embodiments disclosed herein may be to minimize an actuator mechanical stress reducing wear over time.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
an actuator assembly comprising an actuator and a coupling mechanism, said coupling mechanism having a curved surface, said actuator having a leading contact point with said curved surface, said actuator having an end coupled with a stationary point, said actuator comprising a shape memory alloy adapted to pull said coupling mechanism in a direction tangential to said leading contact point toward said stationary point when heated.

2. An apparatus according to claim 1, further comprising an arm coupled with said coupling mechanism, said arm rotatable about a pivot point in a first direction when said actuator is heated.

3. An apparatus according to claim 2, further comprising another actuator assembly comprising another actuator and another coupling mechanism, said another coupling mechanism coupled with said arm, said another coupling mechanism having another curved surface, said another actuator having another leading contact point with said another curved surface, said another actuator having an end coupled with another stationary point, said another actuator comprising a shape memory alloy adapted to pull said another coupling mechanism in a direction tangential to said another leading contact point toward said another stationary point when heated.

4. An apparatus according to claim 3, wherein said arm being rotatable about said pivot point in a second direction when said another actuator is heated.

5. An apparatus according to claim 1, wherein at least a portion of said actuator is helically shaped.

6. An apparatus according to claim 1, wherein at least a portion of said actuator is straight.

7. An apparatus according to claim 1, wherein said actuator is heated by an electric current.

8. An apparatus, comprising:
an actuator assembly comprising an actuator and a coupling mechanism, said coupling mechanism comprising a tap and a bushing, said tap being rotatable with respect to said bushing, said actuator coupled with said tap, said actuator having an end coupled with a stationary point, said actuator comprising a shape memory alloy adapted to pull said coupling mechanism toward said stationary point when heated.

9. An apparatus according to claim 8, further comprising an arm coupled with said coupling mechanism, said arm rotatable about a pivot point in a first direction when said actuator is heated.

10. An apparatus according to claim 9, further comprising another actuator and another coupling mechanism coupled with said arm, said another coupling mechanism comprising another tap and another bushing, said another tap being rotatable with respect to said another bushing, said another actuator coupled with said another tap, said another actuator having an end coupled to another stationary point, said another actuator comprising a shape memory alloy adapted to pull said coupling mechanism toward said another stationary point when heated.

11. An apparatus according to claim 10, wherein said arm being rotatable about said pivot point in a second direction when said another actuator is heated.

12. An apparatus according to claim 8, wherein at least a portion of said actuator is helically shaped.

13. An apparatus according to claim 8, wherein at least a portion of said actuator is straight.

14. An apparatus according to claim 8, wherein said actuator is heated by an electric current.

15. An apparatus, comprising:
an actuator assembly comprising an actuator and a pulley, said pulley having a curved surface, said actuator having a leading contact point with said curved surface, said actuator having an end coupled with a stationary point, said actuator comprising a shape memory alloy adapted to pull said coupling mechanism in a direction tangential to said leading contact point toward said stationary point when heated.

16. An apparatus according to claim 15, further comprising an arm coupled with said pulley, said arm rotatable about a pivot point in a first direction when said actuator is heated.

17. An apparatus according to claim 16, wherein said actuator assembly further comprises another actuator and another pulley coupled with said arm, said another pulley having another curved surface, said another actuator having another leading contact point with said another curved surface, said actuator having an end coupled with another stationary point, said another actuator comprising a shape memory alloy adapted to pull said another coupling mechanism in a direction tangential to said another leading contact point toward said another stationary point when heated.

18. An apparatus according to claim 17, wherein said arm being rotatable about said pivot point in a second direction when said another actuator is heated.

19. An apparatus according to claim 17, wherein said actuator and said another actuator are coupled with an electrical grounding point.

20. An apparatus according to claim 15, wherein at least a portion of said actuator is straight or a helically-shaped.
